(19) United States
(12) Patent Application Publication
(10) Pub. No.: US 2012/0156660 A1
(43) Pub. Date: Jun. 21, 2012

(54) DIALOGUE METHOD AND SYSTEM FOR THE SAME

(75) Inventors: Oh Woog KWON, Daejeon (KR); Sung Kwon CHOI, Daejeon (KR); Ki Young LEE, Daejeon (KR); Yoon Hyung ROH, Daejeon (KR); Young Kil KIM, Daejeon (KR); Eun Jin PARK, Daejeon (KR); Yun JIN, Daejeon (KR); Chang Hyun KIM, Daejeon (KR); Young Ae SEO, Daejeon (KR); Seong YANG, II, Daejeon (KR); Jin Xia HUANG, Daejeon (KR); Jong Hun SHIN, Busan (KR); Yun Keun LEE, Daejeon (KR); Sang Kyu PARK, Daejeon (KR)

(73) Assignee: Electronics and Telecommunications Research Institute, Daejeon (KR)

(21) Appl. No.: 13/327,392

(22) Filed: Dec. 15, 2011

(30) Foreign Application Priority Data
Dec. 16, 2010 (KR) 10-2010-0129360

(51) Int. Cl. G09B 19/04

(52) U.S. Cl. 434/185

(57) ABSTRACT

A dialogue system include learning initiation unit which receives conversation education domain and target completion condition inconversation education domain and receives user's utterance, voice recognition unit which converts user's utterance into utterance text based on utterance information, language understanding unit which determines user's dialogue act based on converted utterance text and generates logical expression using slot expression corresponding to determined dialogue act and slot expression defined in conversation education domain, dialogue/progress management unit which determines utterance vertex with logical expression similar to that of utterance patterns of plurality of utterance vertices connected to system's final utterance vertex in dynamic dialogue graph and determines utterance vertices connected to determined utterance vertex as next utterance, system dialogue generation unit which retrieves utterance patterns connected to utterance vertex corresponding to determined next utterance and generates system's utterance sentence, and voice synthesizer which synthesizes system's utterance sentence into voice and outputs synthesized voice.

### CROSS-REFERENCE TO RELATED PATENT APPLICATION

This application claims the benefit of Korean Patent Application No. 10-2010-0129360, filed on Dec. 16, 2010, in the Korean Intellectual Property Office, the disclosure of which is incorporated herein in its entirety by reference.

### BACKGROUND OF THE INVENTION

1. Field of the Invention

The present invention relates to a dialogue method and a system for the same and, more particularly, to a dialogue method which makes an utterance adaptively in response to a user's utterance based on the user's learning progress and a system for the same.

2. Description of the Related Art

It is considered that the best way to learn a foreign language is to live in a country where the language is spoken while becoming familiar with the culture and customs and the second best way is to learn the foreign language from a native-speaking teacher at home. However, the cost of learning a foreign language is very high, which imposes a significant economic burden. Moreover these traditional foreign language learning methods have spatial and temporal restrictions on visiting a foreign country or having regular meeting with a native-speaking teacher.

To overcome the spatial and temporal restrictions of the conventional foreign language learning methods, various computer-aided learning methods have recently been released. The conventional computer-aided foreign language learning methods just provide simple information, learning data, ways to solve, etc. Moreover, in connection with foreign language conversation education, a dialogue gradually develops on a given scenario such that a learner learns a foreign language in given sentences and situations, which is problematic.

To solve such problems, various methods of using dialogue systems, in which a computer conducts a dialogue on behalf of a native speaker, in the foreign language conversation education have been proposed. The conventional dialogue systems have provided information services such as ticket hotel/train/airline reservations, bus route/room guides, etc. by conducting a dialogue with a user to identify the reservation or information that the user wants. If these conventional dialogue systems have been developed for English conversation, they can be used to learn English conversation in reservation domains such as hotel, airline tickets, etc. or guide domains such as bus route or room search.

A foreign language conversation education system based on a dialogue system can provide a dialogue on behalf of a native-speaking teacher, which imposes spatial and temporal restrictions and high costs, and can provide a dialogue that can respond to the user's reactions. Dialogue management methods, which manage the dialogue flow with the user in existing dialogue systems, use dialogue plans prepared by experts in individual domains or dialogue responses learned from domain dialogue scenarios to serve the user's purposes such as hotel reservation services, information services, etc. In the case of the dialogue system for the foreign language conversation education, if the user cannot make the following dialogue under certain circumstances, the dialogue system should propose the following dialogue or facilitate the progress of the dialogue.

Plan based dialog systems can identify the dialogue flow to progress based on the dialogue plans and provide assistance to a learner. However, a data-driven dialog system is not based on a dialogue plan, from which the dialogue flow can be identified, but based on an actual dialogue to respond to the user's utterance through learning. Thus, the data-based dialog system cannot predict the user's next utterance in the current situation and thus cannot suggest the next sentence that the user speaks.

Thus, when the dialogue system based on the practices is used for the foreign language conversation education, the existing dialogue plans have been adopted to predict the next utterance, thereby providing assistance to the user. Unlike the dialogue system based on learning and practices, in the case of the dialogue system based on dialogue plans created by experts, the dialogue with the learner should be limited to the predetermined dialogue plans, which is problematic.

The existing dialogue systems have been developed in view of the dialogue flow in information services for certain purposes, and thus such dialogue systems are the dialogue management methods based on dialogue plans that consider only the predetermined dialogue flows or based on learning and practices that are difficult to control the dialogue flow. Therefore, it is necessary to provide a method that is suitable for the foreign language conversation education and can control the dialogue flow by considering various dialogue flows occurring in actual domains. Moreover, the existing dialogue systems are configured such that the dialogue proceeds with an optimal dialogue flow at all times to provide prompt and accurate information services to the user regardless of the plan based or data driven method. In most dialogue systems, the best condition is a short dialogue flow, and thus the system conducts a dialogue as short as possible. If the user is not familiar with various foreign languages, the system conducts the same dialogue as the user's utterance, and thus the user cannot encounter various dialogue flows in the dialogue system.

Moreover, the conventional dialogue systems for the foreign language conversation education cannot control various dialogue flows based on the learning progress of the learner and thus cannot provide a variety of experiences, and the dialogue levels of the system are not differentiated based on the learner's progress, which is very problematic.

### SUMMARY OF THE INVENTION

The present invention has been made in an effort to solve the above-described problems associated with prior art, and a first object of the present invention is to provide a dialogue system which makes an utterance adaptively in response to a user's utterance based on the user's learning progress.

A second object of the present invention is to provide a dialogue method which allows a dialogue system to make an utterance adaptively in response to a user's utterance based on the user's learning progress.

A third object of the present invention is to provide a method for generating a dynamic dialogue graph which allows a dialogue system to make an utterance adaptively in response to a user's utterance based on the user's learning progress.

According to an aspect of the present invention to achieve the first object of the present invention, there is provided a dialogue system comprising: a learning initiation unit which receives a conversation education domain and a target completion condition in the conversation education domain from a user and receives the user's utterance made by the user; a voice recognition unit which converts the received user's utterance into a utterance text based on utterance information; a language understanding unit which determines the user's dialogue act based on the converted utterance text and generates a logical expression using a slot expression corresponding to the determined dialogue act and a slot expression defined in the conversation education domain; a dialogue/progress management unit which determines an utterance vertex with a logical expression similar to that of utterance patterns of a plurality of utterance vertices connected to the system's final utterance vertex in a dynamic dialogue graph and determines one of the plurality of utterance vertices connected to the determined utterance vertex as the next utterance; a system dialogue generation unit which retrieves utterance patterns connected to the utterance vertex corresponding to the determined next utterance and generates the system's utterance sentence; and a voice synthesizer which synthesizes the generated system's utterance sentence into a voice and outputs the synthesized voice.

According to another aspect of the present invention to achieve the second object of the present invention, there is provided a dialogue method comprising: receiving a conversation education domain and a target completion condition in the conversation education domain from a user and receiving the user's utterance made by the user; converting the received user's utterance into a utterance text based on utterance information; determining the user's dialogue act based on the converted utterance text and generating a logical expression using a slot expression corresponding to the determined dialogue act and a slot expression defined in the conversation education domain; determining an utterance vertex with a logical expression similar to that of utterance patterns of a plurality of utterance vertices connected to the system's final utterance vertex in a dynamic dialogue graph and determining one of the plurality of utterance vertices connected to the determined utterance vertex as the next utterance; retrieving utterance patterns connected to the utterance vertex corresponding to the determined next utterance and generating the system's utterance sentence; and synthesizing the generated system's utterance sentence into a voice and outputting the synthesized voice.

According to still another aspect of the present invention to achieve the third object of the present invention, there is provided a method for generating a dialogue graph, the method comprising: constructing a dialogue scenario between a user and a system in an education domain selected by the user; generating a dialogue scenario corpus to which dialogue process information is attached by setting a dialogue act and a slot expression with respect to each dialogue included in the constructed dialogue scenario and assigning a slot type to each slot expression word; constructing utterance vertices of the dialogue graph based on the dialogue process information attached to the dialogue scenario corpus and generating the utterance pattern of the utterance vertex based on the slot type; and imparting a directed edge to the utterance vertices based on dialogues included in the dialogue scenario and constructing the dialogue graph by learning a transition relationship between the slots to satisfy a target completion condition in the education domain received from the user.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing the internal structure of a dialogue system in accordance with an exemplary embodiment of the present invention;

FIG. 2 is a schematic diagram showing the internal structure of a language understanding unit of the dialogue system in accordance with an exemplary embodiment of the present invention;

FIG. 3 is a schematic diagram showing the internal structure of a dynamic dialogue graph generation unit of the dialogue system in accordance with an exemplary embodiment of the present invention;

FIG. 4 is a diagram showing an example of a dynamic dialogue graph in a conversation education domain in accordance with an exemplary embodiment of the present invention;

FIG. 5 is a diagram showing an example of a diagram pattern connected to a dialogue vertex of a dynamic dialogue graph in accordance with an exemplary embodiment of the present invention;

FIG. 6 is a flowchart showing a dialogue method in an educational dialogue system in accordance with an exemplary embodiment of the present invention; and

FIG. 7 is a flowchart showing a method for generating a dynamic dialogue graph in the educational dialogue system in accordance with an exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

Although the exemplary embodiments of the present invention will be described based on an English dialogue system, it should be noted that the dialogue language is not limited to English.

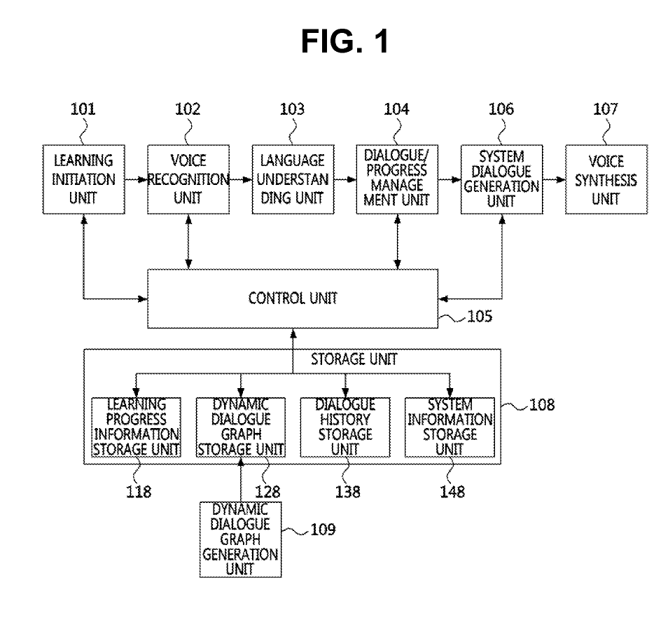

FIG. 1 is a schematic diagram showing the internal structure of a dialogue system in accordance with an exemplary embodiment of the present invention.

Referring to FIG. 1, a dialogue system may comprise a learning initiation unit 101, a voice recognition unit 102, a language understanding unit 103, a dialogue/progress management unit 104, a control unit 105, a system dialogue generation unit 106, a voice synthesis unit 107, a storage unit 108, and a dynamic dialogue graph generation unit 109. The storage unit 108 may comprise a learning progress information storage unit 118, a dynamic dialogue graph storage unit 128, a dialogue history storage unit 138, and a system information storage unit 148.

The learning initiation unit 101 receives a conversation education domain to educate among a plurality of conversation education domains from a user. According to an exemplary embodiment of the present invention, when the user logs into a dialogue system for foreign language conversation education and selects a conversation education domain to learn from the plurality of conversation education domains, the learning initiation unit 101 receives the selected conversation education domain from the user. According to an exemplary embodiment of the present invention, the plurality of conversation education domains represent the subjects of dialogue scenarios between the dialogue system and the user and may include, but not limited to, a city tour bus ticket purchase domain, a hotel reservation domain, a hotel check-in and check-out domain, a lost and found search domain, etc.

Moreover, the learning initiation unit 101 sets a dynamic dialogue graph and system information based on a learning progress of the conversation education domain selected by the user under the control of the control unit 105. First, a case where the learning initiation unit 101 determines that the learning progress of the conversation education domain is the first as the user selects a new conversation education domain will be described below. The learning initiation unit 101 sets a dynamic dialogue graph and system information based on the learning progress of the conversation education domain selected by the user under the control of the control unit 105. Second, a case where the learning initiation unit 101 determines that the learning progress of the conversation education domain is not the first as the user selects the previously selected conversation education domain will be described below. The learning initiation unit 101 sets a dynamic dialogue graph and system information based on the learning progress of the conversation education domain selected by the user under the control of the control unit 105.

Moreover, the learning initiation unit 101 receives a target completion condition in the conversation education domain selected by the user. According to an exemplary embodiment of the present invention, when the user selects a city tour bus ticket purchase domain from the plurality of conversation education domains, the learning initiation unit 101 receives the selected target completion condition in the conversation education domain from the user, such as the attendance of a specific tour, the purchase of a bus ticket below a certain cost, the use of a Korean guide, the purchase of a city tour ticket for a desired destination, the determination of whether the type of city tour bus is at night or day, etc.

The reasons that the learning initiation unit 101 receives the target completion condition in the conversation education domain from the use rare to allow the user who is not familiar with the domain to clearly understand what to do. Moreover, the conversation level of the user tends to increase as the number of conditions that the user should complete increases, and thus, when it is the first experience for the user, the target completion condition in the conversation education domain is provided to the user such that the user can complete the target based on the experiences of the target completion condition. Furthermore, more complex conditions are provided to the user based on the increase in the number of experiences and based on the success of the experience such that the user can experience the more complex condition. In addition, the user can practice the foreign language conversation in a variety of situations in one domain which may be boring to the user, thereby maximizing the repetitive learning effect. Additionally, the user can further recognize the various conditions to naturally learn the foreign culture and customs provided in the domain. Also, the user can complete the target at the user's free will based on the user's selection without conditions provided by the system.

The learning initiation unit 101 receives the user's utterance made by the user or makes an utterance to provide the system's utterance to the user. First, a case where the learning initiation unit 101 receives the user's utterance made by the user will be described below. Generally, the system first makes an utterance such as “Welcome to the New York City Bus Tour Center”. However, the user may make an utterance such as “Hello” or “Hello, I want to buy tickets”. When starting with user's utterance, the voice recognition unit 102 of the dialogue system recognizes the user's utterance under the control of the control unit 105. Second, a case where learning initiation unit 101 makes the system's utterance to the user will be described below. For example, the system first makes an utterance such as “Welcome to the New York City Bus Tour Center” in the city tour bus ticket purchase domain. When starting with the system's utterance, after the user completes the selection in the learning initiation unit 101, the dialogue/progress management unit 104 selects the system's utterance under the control of the control unit 105.

When the user's utterance is received from the user through the learning initiation unit 101, the voice recognition unit 102 converts the received user's utterance into an utterance text using utterance information. According to an exemplary embodiment of the present invention, the voice recognition unit 102 converts the user's utterance received from the user through the learning initiation unit 101 into the utterance text using foreign language utterance information made by a plurality of other users of the same nationality as the user to increase the recognition rate of the user's utterance. According to an exemplary embodiment of the present invention, if the user's utterance received through the learning initiation unit 101 is not natural, for example, if the user makes an utterance including repeated words or phrases, or if the user makes an utterance again, the voice recognition unit 102 removes interjections and the like, which are the phonetic features occurring in a natural language, thus converting the received user's utterance into the utterance text.

The language understanding unit 103 determines the user's dialogue act using the utterance text converted by the voice recognition unit 102 and generates a logical expression using a slot expression corresponding to the determined dialogue act and a slot expression defined in the conversation education domain. According to an exemplary embodiment of the present invention, in the case where the user selects the city tour bus ticket purchase domain from the plurality of conversation education domains, when receiving the utterance text such as “Which tour goes to the Statue of Liberty?” with respect to the user's utterance from the voice recognition unit 102, the language understanding unit 103 determines that the user's dialogue act corresponds to a request and generates a logical expression. For example, the logical expression may be a request (location=“State of Liberty”, tour_type), but not limited thereto.

The dialogue/progress management unit 104 stores the system's final utterance vertex in the dialogue history storage unit 138 of the storage unit 108 under the control of the control unit 105.

The dialogue/progress management unit 104 retrieves the user's utterance vertex on a graph with respect to the user's current utterance using a dialogue history stored in the dialogue history storage unit 138 of the storage unit 108 under the control of the control unit 105. Here, the user's utterance vertex retrieved by the dialogue/progress management unit 104 may be or may not be directly connected to the system's final utterance vertex. First, a case where the user's utterance vertex retrieved by the dialogue/progress management unit 104 is directly connected to the system's final utterance vertex will be described below. The dialogue/progress management unit 104 retrieves the user's utterance vertex directly connected to the system's final utterance vertex based on the logical expression generated by and received from the language understanding unit 103 and the current slot history of the user's current utterance or retrieves the system's utterance vertex having a high weight and less learned from the system's utterance vertices connected to the retrieved user's utterance vertex, thus making an utterance.

Second, a case where the user's utterance vertex retrieved by the dialogue/progress management unit 104 is not directly connected to the system's final utterance vertex will be described below. This case corresponds to a case where the user's utterance vertex corresponding to the user's current utterance is not present when the dialogue/progress management unit 104 retrieves the user's utterance vertex directly connected to the system's final utterance vertex based on the logical expression generated by and received from the language understanding unit 103 and the current slot history of the user's current utterance. Accordingly, the dialogue/progress management unit 104 retrieves the user's utterance vertex from the entire dynamic dialogue graph based on the logical expression generated by and received from the language understanding unit 103 and the current slot history of the user's current utterance and retrieves the system's utterance vertex having a high weight and less learned from the system's utterance vertices connected to the retrieved user's utterance vertex, thus making an utterance.

Next, a process in which the dialogue/progress management unit 104 determines the system's utterance vertex, which will be used in the next utterance, from a plurality of system's utterance vertices connected to the user's utterance vertex corresponding to the user's current utterance will be described.

The dialogue/progress management unit 104 may determine whether the learning of the user is the first or not based on the learning progress information stored in the learning progress information storage unit 118 of the storage unit 108 under the control of the control unit 105, thereby determining the system's utterance vertex. First, a case where the dialogue/progress management unit 104 determines the system's utterance vertex as it is determined that the learning of the user is the first based on the learning progress information stored in the learning progress information storage unit 118 of the storage unit 108 under the control of the control unit 105 will be described below. The dialogue/progress management unit 104 determines the system's utterance vertex connected to an edge having the highest weight among the plurality of system's utterance vertices connected to the user's utterance vertex retrieved from the dynamic dialogue graph stored in the dynamic dialogue graph storage unit 128 of the storage unit 108 under the control of the control unit 105. As such, the dialogue/progress management unit 104 determines the system's utterance vertex connected to the edge having the highest weight and induces a dialogue flow which may be the easiest in the current situation.

Second, a case where the dialogue/progress management unit 104 determines the system's utterance vertex as it is determined that the learning of the user is not the first based on the learning progress information stored in the learning progress information storage unit 118 of the storage unit 108 under the control of the control unit 105 will be described below. In this case, the dialogue/progress management unit 104 may evaluate the user's learning progress rate based on the learning progress information stored in the learning progress information storage unit 118 of the storage unit 108 under the control of the control unit 105 and determine the system's utterance vertex based on the result. First, a case where the dialogue/progress management unit 104 evaluates that the user's learning progress rate is low based on the learning progress information stored in the learning progress information storage unit 118 of the storage unit 108 under the control of the control unit 105 will be described below. The dialogue/progress management unit 104 receives an edge between the user's utterance vertex and the plurality of system's utterance vertices connected to the user's utterance vertex based on the learning progress information stored in the learning progress information storage unit 118 of the storage unit 108 under the control of the control unit 105 and, if there is an edge that requires the user's repetitive learning, determines the system's utterance vertex connected to the edge.

Second, a case where the dialogue/progress management unit 104 evaluates that the user's learning progress rate is high based on the learning progress information stored in the learning progress information storage unit 118 of the storage unit 108 under the control of the control unit 105 will be described below. The dialogue/progress management unit 104 determines the system's utterance vertex connected to the highest edge, at which the user does not perform the learning, among the plurality of system's utterance vertices connected to the user's utterance vertex in the dynamic dialogue graph stored in the dynamic dialogue graph storage unit 128 of the storage unit 108 under the control of the control unit 105, thereby determining the next utterance. If it is determined that there are a plurality of system's utterance vertices connected to the user's utterance vertex in the dynamic dialogue graph stored in the dynamic dialogue graph storage unit 128 of the storage unit 108 under the control of the control unit 105, the dialogue/progress management unit 104 determines a vertex corresponding to the system's utterance vertex, in which the number of visits by the user is the lowest, based on the learning progress information of the system's utterance vertex connected to the edge having the highest weight in the dynamic dialogue graph stored in the dynamic dialogue graph storage unit 128 of the storage unit 108 under the control of the control unit 105.

The dialogue/progress management unit 104 may determine the user's learning degree based on the learning progress information stored in the learning progress information storage unit 118 of the storage unit 108 under the control of the control unit 105. First, a case where the dialogue/progress management unit 104 determines that the user's learning is not sufficient based on the learning progress information stored in the learning progress information storage unit 118 of the storage unit 108 under the control of the control unit 105 will be described below. If it is determined that the similarity between the user's utterance pattern and the utterance pattern of the user's utterance vertex is low based on the learning progress information stored in the learning progress information storage unit 118 of the storage unit 108 under the control of the control unit 105, the dialogue/progress management unit 104 determines that the user does not sufficiently learn the content of the dialogue based on the user's corresponding utterance vertex, thereby determining the next utterance.

Second, a case where the dialogue/progress management unit 104 determines that the user's learning is sufficient based on the learning progress information stored in the learning progress information storage unit 118 of the storage unit 108 under the control of the control unit 105 will be described below. If it is determined that the similarity between the user's utterance pattern and the utterance pattern of the user's utterance vertex is high based on the learning progress information stored in the learning progress information storage unit 118 of the storage unit 108 under the control of the control unit 105, the dialogue/progress management unit 104 determines that the user sufficiently learns the content of the dialogue based on the user's corresponding utterance vertex, thereby determining the next utterance.

As one of the plurality of system's utterance vertices connected to the user's utterance vertex is selected, the dialogue/progress management unit 104 updates the number of visits with respect to the edge between the user's utterance vertex and the system's utterance vertex in the learning progress information storage unit 118 of the storage unit 108 and updates the weight in the dynamic dialogue graph storage unit 128 of the storage unit 108 through the control unit 105. First, a case where the dialogue/progress management unit 104 determines the system's utterance vertex in the dynamic dialogue graph stored in the dynamic dialogue graph storage unit 128 of the storage unit 108 and updates the learning progress information storage unit 118 of the storage unit 108 through the control unit 105 as it is determined that the user's learning degree is low based on the learning progress information stored in the learning progress information storage unit 118 of the storage unit 108 under the control of the control unit 105 will be described. As it is determined that the similarity between the user's utterance pattern and the utterance pattern of the user's utterance vertex is low based on the learning progress information stored in the learning progress information storage unit 118 of the storage unit 108 under the control of the control unit 105, the dialogue/progress management unit 104 determines that the user's learning degree is low, updates the number of visits with respect to the edge between the system's previous utterance vertex and the user's current utterance vertex in the dynamic dialogue graph in the learning progress information storage unit 118 of the storage unit 108 through the control unit 105, reduces the weight of the edge between the user's previous utterance vertex and the system's previous utterance vertex, and updates the dynamic dialogue graph storage unit 128 of the storage unit 108 through the control unit 105.

Second, a case where the dialogue/progress management unit 104 determines the system's utterance vertex in the dynamic dialogue graph and updates the learning progress information storage unit 118 of the storage unit 108 through the control unit 105 as it is determined that the user's learning degree is high based on the learning progress information stored in the learning progress information storage unit 118 of the storage unit 108 under the control of the control unit 105 will be described. As it is determined that the similarity between the user's utterance pattern and the utterance pattern of the user's utterance vertex is high based on the learning progress information stored in the learning progress information storage unit 118 of the storage unit 108 under the control of the control unit 105, the dialogue/progress management unit 104 determines that the user's learning degree is high, updates the number of visits with respect to the edge between the system's current utterance vertex and the user's current utterance vertex in the dynamic dialogue graph in the learning progress information storage unit 118 of the storage unit 108 through the control unit 105, increases the weight of the edge between the user's previous utterance vertex and the system's previous utterance vertex, and updates the dynamic dialogue graph storage unit 128 of the storage unit 108 through the control unit 105.

The control unit 105 stores the dynamic dialogue graph and the system information set by the dialogue/progress management unit 104 based on the learning progress of the conversation education domain selected by the user in the learning progress information storage unit 118 and the dialogue history storage unit 138 of the storage unit 108, respectively. First, a case where the control unit 105 stores the dynamic dialogue graph and the system information in the learning progress information storage unit 118 and the dialogue history storage unit 138 of the storage unit 108 as the dialogue/progress management unit 104 determines that the learning progress of the conversation education domain is the first will be described. The control unit 105 stores the dynamic dialogue graph and the system information, in which the learning progress of the conversation education domain is initially set by determining that the learning progress of the conversation education domain is the first as the user selects a new conversation education domain, in the learning progress information storage unit 118 and the dialogue history storage unit 138 of the storage unit 108, respectively.

Second, a case where the control unit 105 stores the dynamic dialogue graph and the system information in the learning progress information storage unit 118 and the dialogue history storage unit 138 of the storage unit 108 as the dialogue/progress management unit 104 determines that the learning progress of the conversation education domain is not the first will be described. The control unit 105 stores the dynamic dialogue graph and the system information, in which the learning progress of the conversation education domain is not initially set by determining that the learning progress of the conversation education domain is not the first as the user selects the previously selected conversation education domain, in the learning progress information storage unit 118 and the dialogue history storage unit 138 of the storage unit 108, respectively.

As the dialogue/progress management unit 104 determines the next utterance, the control unit 105 stores the learning progress information and the dialogue system in the learning progress information storage unit 118 and the dialogue history storage unit 138 of the storage unit 108, respectively. First, in the case where the dialogue/progress management unit 104 determines whether the utterer who finally utters is the user or the system and determines one of the plurality of system's utterance vertices connected to the current utterance vertex in the dynamic dialogue graph, the control unit 105 controls the dialogue history indicating a vertex, at which the utterance is made in the dynamic dialogue graph, in the dialogue history storage unit 138 and stores the number of visits to the edge between the user's utterance vertex and the system's utterance vertex in the learning progress information storage unit 118 of the storage unit 108.

Second, a case where the dialogue/progress management unit 104 determines the next utterance based on the user's learning degree will be described below. First, as the dialogue/progress management unit 104 determines that the user's learning degree is low, the control unit 105 reduces the number of visits to the edge between the system's previous utterance vertex and the user's current utterance vertex in the dynamic dialogue graph and the weight of the edge between the user's previous utterance vertex and the system's previous utterance vertex, and stores them in the dynamic dialogue graph storage unit 128 of the storage unit 108. Second, as the dialogue/progress management unit 104 determines that the user's learning degree is high, the control unit 105 increases the number of visits to the edge between the system's previous utterance vertex and the user's current utterance vertex in the dynamic dialogue graph and the weight of the edge between the user's previous utterance vertex and the system's previous utterance vertex, and stores them in the dynamic dialogue graph storage unit 128 of the storage unit 108.

The system dialogue generation unit 106 receives the system's utterance vertex determined by the dialogue/progress management unit 104, retrieves the utterance patterns connected to the system's utterance vertex, received from the dialogue/progress management unit 104, from the dynamic dialogue graph received from the storage unit 108 under the control of the control unit 105, and generates the system's utterance based on the utterance patterns. According to an exemplary embodiment of the present invention, if it is determined that the utterance pattern of the system's utterance vertex, received from the dialogue/progress management unit 104, does not include a slot type in the dynamic dialogue graph received from the storage unit 108 under the control of the control unit 105, the system dialogue generation unit 106 may use the utterance pattern as the system's utterance sentence depending on the type of slot expression included in the utterance vertex received from the dialogue/progress management unit 104 or use a retrieved sentence based on the dialogue history received from the storage unit 108 under the control of the control unit 105.

According to an exemplary embodiment of the present invention, if it is determined that the utterance pattern of the system's utterance vertex, received from the dialogue/progress management unit 104, includes a slot type in the dynamic dialogue graph received from the dynamic dialogue graph storage unit 128 of the storage unit 108 under the control of the control unit 105, the system dialogue generation unit 106 retrieves a value corresponding to “LOCATION” as the utterance pattern of the system's utterance vertex from the system information received from the system information storage unit 148 of the storage unit 108 and a value corresponding to “TOUR TYPE” as the utterance pattern of the system's utterance vertex to complete a sentence and uses the sentence as the system's utterance sentence. Here, the utterance pattern may have the frequency shown in a dialogue scenario corpus, and the level of difficulty of the utterance is calculated by calculating the distribution of English words that are not frequently used. Moreover, the English words that are not frequently used may include words that are not present in elementary/middle/high school textbooks or words with low frequencies in a large English corpus.

The voice synthesis unit 107 receives the system's utterance sentence generated by the system dialogue generation unit 106, synthesizes the received system's utterance sentence into a voice, and outputs the synthesized voice.

The learning progress information storage unit 118 stores the edge between the user's utterance vertex and the system's utterance vertex and the number of visits to the system's utterance vertex. According to an exemplary embodiment of the present invention, the learning progress information storage unit 118 stores edge information in the dynamic dialogue graph passing during dialogue with the system in the same conversation education domain, the number of visits to the system's utterance vertex, and the similarity between the user's utterance pattern and the utterance pattern of the user's utterance vertex.

The dynamic dialogue graph storage unit 128 stores the dynamic dialogue graph received from the dynamic dialogue graph generation unit 109. The dialogue history storage unit 138 stores the vertex in the dynamic dialogue graph at which the content mentioned in the dialogue occurs during the dialogue between the user and the system.

The system information storage unit 148 stores the system information based on the conversation education domain. According to an exemplary embodiment of the present invention, in the case where the conversation education domain is the city tour bus ticket domain, the system information storage unit 148 stores information on each city tour bus from a bus ticket seller such as price, type of tour, expiration date, departure time, bus route, etc.

The dynamic dialogue graph generation unit 109 constructs the vertices of the dialogue graph using the dialogue scenario between the system and the user in the conversation education domain selected by the user, generates the utterance pattern for each vertex using the utterance sentences of the dialogue scenario to which slot expression information is attached, and imparts a directed edge to the vertices based on the flow of the dialogue scenario, thereby generating the dynamic dialogue graph.

Here, the dynamic dialogue graph is a directed graph with a plurality of vertices and edges, and the vertices comprise the system's utterance vertex and the user's utterance vertex and store a set of slot expressions, which are run through the graph such as the dialogue act, the slot expression, and the current utterance vertex, as the dialogue history. The edge represents the dialogue flow between the user and the system and is connected to a plurality of vertices for the utterances to be made after the current utterance vertex.

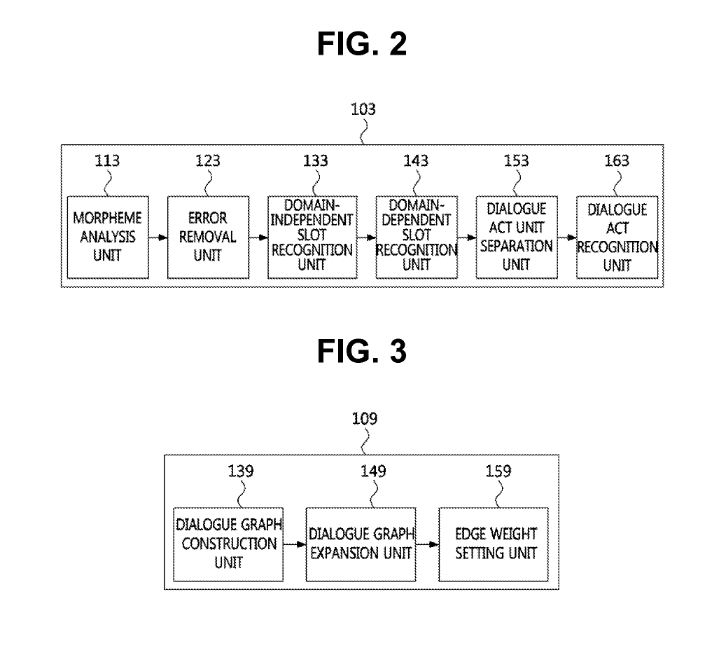

FIG. 2 is a schematic diagram showing the internal structure of the language understanding unit 103 of the dialogue system in accordance with an exemplary embodiment of the present invention.

Referring to FIG. 2, the language understanding unit 103 may comprise a morpheme analysis unit 113, an error removal unit 123, a domain-independent slot recognition unit 133, a domain-dependent slot recognition unit 143, a dialogue act unit separation unit 153, and a dialogue act recognition unit 163.

The morpheme analysis unit 113 receives the utterance text converted from the user's utterance by the voice recognition unit 102, separates the received utterance text into a plurality of sentences and words, and assigns parts of speech to the plurality of separated words.

The error removal unit 123 removes errors from the utterance text when the user's utterance is not natural. According to an exemplary embodiment of the present invention, if the user's dialogue is not natural, for example, if the user makes an utterance including repeated words or phrases, or if the user makes the utterance again, the error removal unit 123 retrieves and removes the errors using existing utterance analysis data from the repeated words or phrases occurring in the user's utterance.

The domain-independent slot recognition unit 133 recognizes slot expressions used commonly in all of the conversation education domains such as data, time, currency unit, etc. The domain-dependent slot recognition unit 143 inspects and recognizes the slot expressions in the user's utterance based on a statistical learning method with respect to different slots in each conversation education domain.

The dialogue act unit separation unit 153 recognizes the range of dialogue acts which are different depending on phrase units even though the utterances are made by the same user and separates the utterances in units of dialogue acts. The dialogue act recognition unit 163 recognizes the accurate dialogue act from the separated dialogue act units based on a statistical learning pattern.

FIG. 3 is a schematic diagram showing the internal structure of the dynamic dialogue graph generation unit 109 of the dialogue system in accordance with an exemplary embodiment of the present invention.

Referring to FIG. 3, the dynamic dialogue graph generation unit 109 may comprise a dialogue graph construction unit 139, a dialogue graph expansion unit 149, and an edge weight setting unit 159.

A scenario and corpus construction constructs a dialogue scenario between the user and the system in the conversation education domain selected by the user, sets a dialogue act and a slot expression with respect to each dialogue included in the constructed dialogue scenario, and assigns a slot type to each slot expression word, thereby generating a dialogue scenario corpus to which dialogue process information is attached. According to an exemplary embodiment of the present invention, the scenario and corpus construction represents the subject of the dialogue scenario between the dialogue system and the user in the conversation education domain selected by the user, and the conversation education domain may include, but not limited to, a city tour bus ticket purchase domain, a hotel reservation domain, a hotel check-in and check-out domain, a lost and found search domain, etc.

The dialogue graph construction unit 139 constructs vertices of the dialogue graph based on the dialogue scenario corpus constructed by and received from the scenario and corpus construction, generates the utterance pattern with respect to each vertex based on the utterance sentence of the dialogue scenario to which the slot expression information is attached, and imparts a directed edge to the vertices based on the flow of the dialogue scenario, thereby constructing a dialogue graph. The dialogue graph expansion unit 149 generates an automatic dialogue scenario by removing the slot having a low probability of utterance from the slots before the current slot in the dialogues included in the dialogue scenario based on the transition relationship between the slots and expands the dialogue graph based on the generated automatic dialogue scenario.

The edge weight setting unit 159 receives the expanded dialogue graph from the dialogue graph expansion unit 149 and puts a weight on the edge based on information such as the flow frequency between the individual vertices, the length of each utterance sentence, the level of difficulty of each word, the number of edges remaining till the final dialogue, whether the utterer of the next utterance is the system or the user, etc. in the dialogue graph.

Next, a process in which the edge weight setting unit 159 puts the weight on the edge will be described.

First, the edge weight setting unit 159 receives the expanded dialogue graph from the dialogue graph expansion unit 149, measures the average length of words of the utterance and the level of difficulty of words, which represent the vertex in the dialogue graph, and puts a high weight on the edge depending on the dialogue flow in which the use can easily make an utterance.

Second, the edge weight setting unit 159 determines that the words that are not present in elementary/middle/high school textbooks or words with low frequencies in a large English corpus as the English words that are not frequently used, and determines the level of difficulty of the utterance by calculating the distribution of English words that are not frequently used, thereby selecting a weight. For example, the level of difficulty of the utterance may be expressed as a value from 1 corresponding to the lowest level of difficulty to 5 corresponding to the highest level of difficulty. Therefore, the above-described dialogue/progress management unit 104 may make an utterance based on the level of difficulty of the utterance with respect to the utterance pattern of the system's utterance vertex, which has been described in detail above and thus a detailed description thereof will be omitted.

Third, the edge weight setting unit 159 receives the expanded dialogue graph from the dialogue graph expansion unit 149, uses the flow frequency such that the system can induce the dialogue flow having a high flow frequency between the vertices in the received dialogue graph, measures the average length of words of the utterance and the level of difficulty of words, which represent the vertex in the dialogue graph, and puts a high weight on the dialogue flow that the use can easily understand and in which the user can easily make an utterance.

Lastly, in the case where the system leads the dialogue, the user can experience the conversation more easily, and thus the edge weight setting unit 159 selects a weight such that the next utterance can be led by the system.

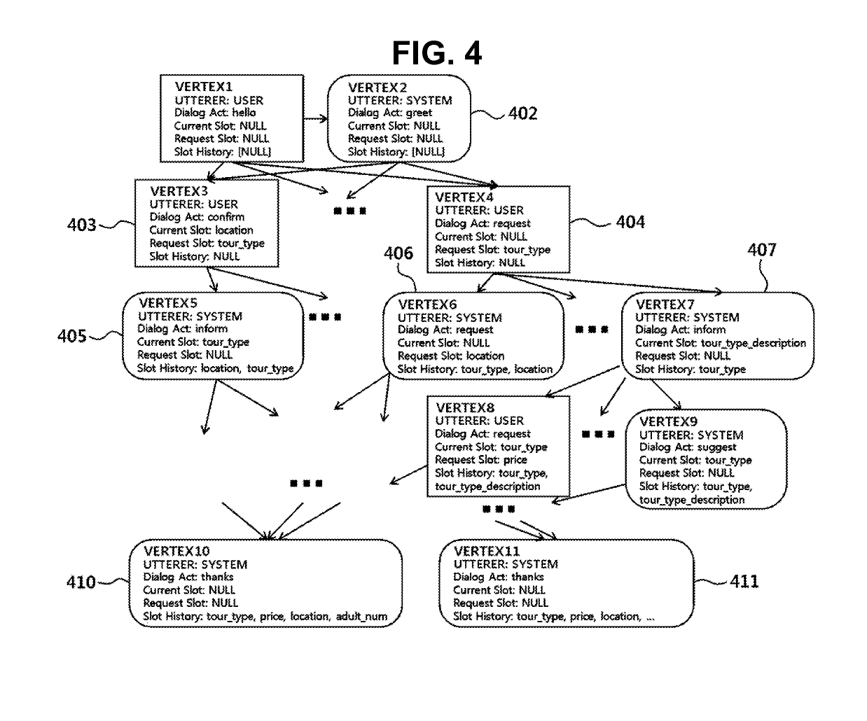

Next, an example of the dynamic dialogue graph of the conversation education domain in accordance with an exemplary embodiment of the present invention will be described in more detail with reference to FIG. 4.

FIG. 4 is a diagram showing an example of the dynamic dialogue graph in the conversation education domain in accordance with an exemplary embodiment of the present invention. FIG. 4 shows the dynamic dialogue graph according to the conversation education domain in the case where the conversation education domain is the city tour bus ticket purchase domain. The dynamic dialogue graph is a directed graph with a plurality of vertices and edges, and the vertices comprise the system's utterance vertex and the user's utterance vertex and store a set of slot expressions, which are run through the graph such as the dialogue act for the current utterance, the slot expression (i.e., current slot) corresponding to the dialogue act, the request slot expression (i.e., request slot) predetermined in the domain, and the current utterance vertex, as the dialogue history. The edge represents the dialogue flow between the user and the system and is connected to a plurality of vertices for the utterances to be made after the current utterance vertex.

The directed edge in the dynamic dialogue graph represents the dialogue flow between the utterance vertices and is connected to a plurality of utterance vertices to be made after the current vertex. The edges of the dialogue graph have weights on the dialogue flow between the vertices. The edge, which is connected to a vertex having a high possibility of being a dialogue flow in which it is easier for the user to achieve the purpose of the dialogue, has a higher weight, and the edge, which is connected to a vertex having a high possibility of being a dialogue flow in which it is more difficult for the user to achieve the purpose of the dialogue, has a lower weight.

Referring to FIG. 4, the dialogue/progress management unit 104 determines that the system's utterance is “Welcome to the New York City Bus Tour Center” based on the dialogue history stored in the dialogue history storage unit 138 of the storage unit 108 under the control of the control unit 105 and retrieves a plurality of user's utterance vertex-3403 and vertex-4404 connected to the system's utterance vertex-2 402. The dialogue/progress management unit 104 moves to the user's utterance vertex corresponding to the user's utterance based on the fact that the edge of the user's utterance vertex-3 403 in the system's utterance vertex-2 402 is an utterance to inquire about the type of city tour to go to a certain location and the edge of the user's utterance vertex-4 404 in the system's utterance vertex-2 402 is an utterance to inquire about the type of city tour.

As the user's utterance is “Which tour goes to the Statue of Liberty?”, the dialogue/progress management unit 104 determines the user's utterance vertex-4 404 corresponding to the user's utterance from the plurality of user's utterance vertex-3 403 and vertex-4 404 connected to the system's utterance vertex-2 402 and selects the next system's utterance vertex from a plurality of system's utterance vertex-6406 and vertex-7 407 connected to the user's utterance vertex-4 404. The dialogue/progress management unit 104 may receive the price of city tour and the type of city tour from the user's utterance or propose the type of a certain city tour with the system's utterance based on the fact that the edge of the system's utterance vertex-6 406 in the user's utterance vertex-4 404 is an utterance to inquire about the type of the city tour to go to a certain location and the edge of the system's utterance vertex-7 407 in the user's utterance vertex-4 404 is an utterance to inform the user of the type of the city tour. The dialogue/progress management unit 104 manages the user's dialogue and progress through the above-described processes, and the dialogue system makes the system's utterance vertex, selected from the system's utterance vertex-10 410 or vertex-11 411, to make the final thanks to the user, thereby finishing the learning.

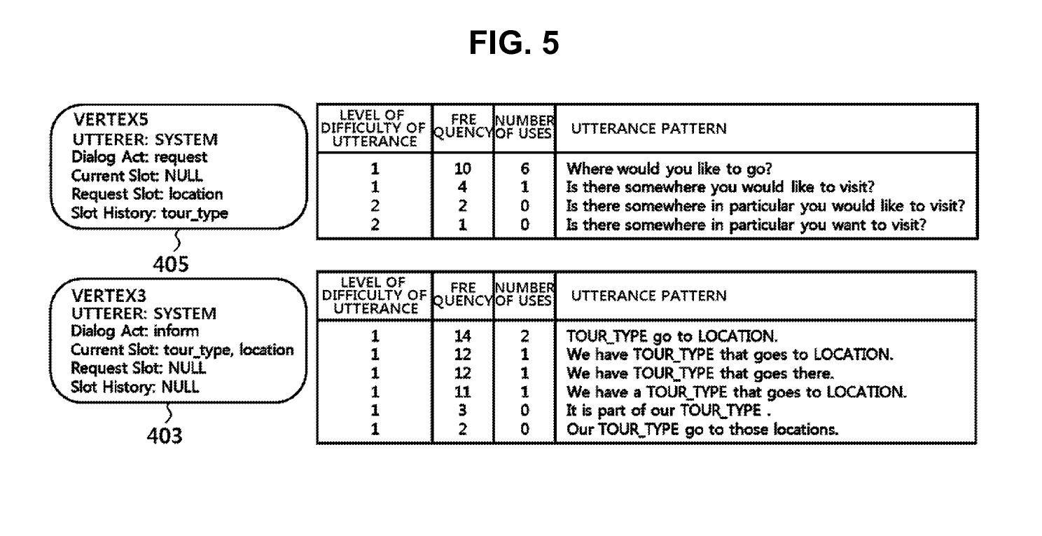

Next, an example of the diagram pattern connected to the dialogue vertex in the dynamic dialogue graph in accordance with an exemplary embodiment of the present invention will be described in more detail with reference to FIG. 5.

FIG. 5 is a diagram showing an example of the diagram pattern connected to the dialogue vertex in the dynamic dialogue graph in accordance with an exemplary embodiment of the present invention.

Referring to FIG. 5, the system dialogue generation unit 106 may generate a system's utterance sentence based on whether a slot type is included in the utterance pattern of the utterance vertex received from the dialogue/progress management unit 104. First, a case where the system dialogue generation unit 106 generates the system's utterance sentence when the slot type is not included in the utterance pattern of the utterance vertex received from the dialogue/progress management unit 104 will be described below. If the slot type (i.e., current slot) in the utterance pattern of the system's utterance vertex-5 405 received from the dialogue/progress management unit 104 is “NULL”, the system dialogue generation unit 106 may use the utterance pattern as the system's utterance sentence depending on the type of the slot expression or use the retrieved sentence based on the dialogue history received from the dialogue history storage unit 138 of the storage unit 108 under the control of the control unit 105.

Second, a case where the system dialogue generation unit 106 generates the system's utterance sentence when the slot type is included in the utterance pattern of the utterance vertex received from the dialogue/progress management unit 104 will be described below. As it is determined that the utterance pattern of the system's utterance vertex-3 403 received from the dialogue/progress management unit 104 is “tour_type” and “location”, the system dialogue generation unit 106 completes a sentence by retrieving a value corresponding to “LOCATION”, which is the utterance pattern of the system's utterance vertex-3 403, and a value corresponding to “TOUR_TYPE”, which is the utterance pattern of the system's utterance vertex-3 403, from the system information received from the dialogue history storage unit 138 of the storage unit 108 under the control of the control unit 105, and uses the sentence as the system's utterance sentence. Here, the utterance pattern may have the frequency shown in a dialogue scenario corpus, and the level of difficulty of the utterance is calculated by calculating the distribution of English words that are not frequently used. Moreover, the English words that are not frequently used may include words that are not present in elementary/middle/high school textbooks or words with low frequencies in a large English corpus.

The level of difficulty of the utterances with respect to the utterance patterns of the system's utterance vertices 403 and 405 of dynamic dialogue graph is expressed as a value from 1 corresponding to the lowest level of difficulty to 5 corresponding to the highest level of difficulty. The dialogue/progress management unit 104 may make an utterance based on the level of difficulty of the utterances with respect to the utterance patterns of the system's utterance vertices 403 and 405. First, if it is determined that the user is in first contact with the system's utterance vertices 403 and 405 or when the user's dialogue flow is not natural based on the learning progress information received from the learning progress information storage unit 118 of the storage unit 108 under the control of the control unit 105, the dialogue/progress management unit 104 makes an utterance using the utterance pattern having a low level of difficulty and a high frequency. On the contrary, if it is determined that the user is in repeated contact with the system's utterance vertices 403 and 405 or when the user's dialogue flow is natural based on the learning progress information received from the learning progress information storage unit 118 of the storage unit 108 under the control of the control unit 105, the dialogue/progress management unit 104 makes an utterance using the utterance pattern having a high level of difficulty and a low frequency. As such, the dialogue/progress management unit 104 makes an utterance using the utterance pattern having a low frequency, thereby providing opportunities to participate in various learning experiences to the user. Here, even when the user is in repeated contact with the system's utterance vertices 403 and 405 or when the user's dialogue flow is natural based on the learning progress information received from the learning progress information storage unit 118 of the storage unit 108 under the control of the control unit 105, if the learning effect is not great as the utterance pattern changes frequently, the dialogue/progress management unit 104 makes an utterance by selecting the utterance pattern having a high frequency (i.e., a large number of uses) or by selecting the utterance pattern based on the probability distribution for each frequency.

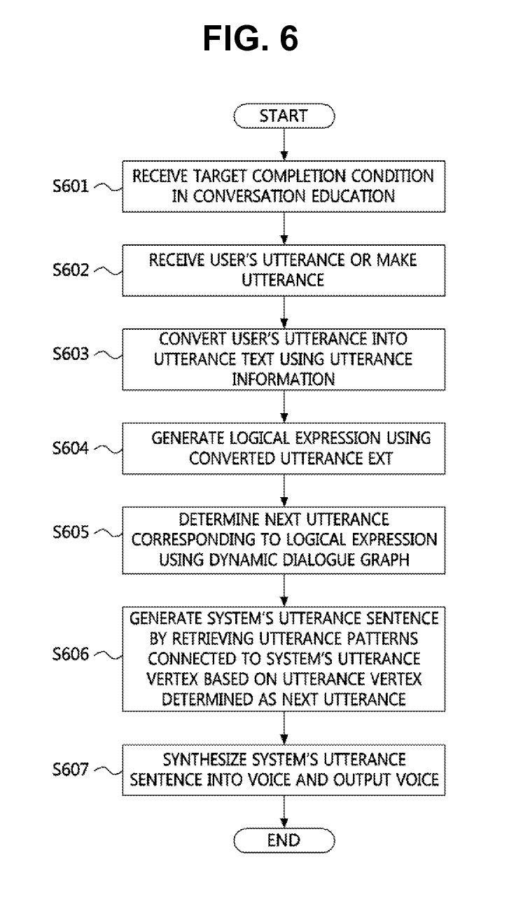

Next, a dialogue method in the educational dialogue system in accordance with an exemplary embodiment of the present invention will be described in more detail with reference to FIG. 6.

FIG. 6 is a flowchart showing a dialogue method in the educational dialogue system in accordance with an exemplary embodiment of the present invention.

Referring to FIG. 6, a dialogue system receives a target completion condition in a conversation education domain from a user (S601). According to an exemplary embodiment of the present invention, when the user logs into a dialogue system for foreign language conversation education and selects a conversation education domain from a plurality of conversation education domains, the dialogue system receives the selected conversation education domain from the user. According to an exemplary embodiment of the present invention, the plurality of conversation education domains represent the subjects of dialogue scenarios between the dialogue system and the user and may include, but not limited to, a city tour bus ticket purchase domain, a hotel reservation domain, a hotel check-in and check-out domain, a lost and found search domain, etc. According to an exemplary embodiment of the present invention, when the user selects a city tour bus ticket purchase domain from the plurality of conversation education domains, the dialogue system receives the selected target completion condition in the conversation education domain from the user, such as the attendance of a specific tour, the purchase of a bus ticket below a certain cost, the use of a Korean guide, the purchase of a city tour ticket for a desired destination, the determination of whether the type of city tour bus is at night or day, etc.

The dialogue system receives the user's utterance made by the user or makes an utterance to provide the system's utterance to the user (S602). First, a case where the dialogue system receives the user's utterance made by the user will be described below. Generally, the system first makes an utterance such as “Welcome to the New York City Bus Tour Center”. However, the user may make an utterance such as “Hello” or “Hello, I want to buy tickets”. Second, a case where the dialogue system provides the system's utterance to the user will be described below. For example the system first makes an utterance such as “Welcome to the New York City Bus Tour Center” in the city tour bus ticket purchase domain. The dialogue system converts the received user's utterance into an utterance text using utterance information (S603). According to an exemplary embodiment of the present invention, the dialogue system converts the user's utterance into the utterance text using foreign language utterance information made by a plurality of other users of the same nationality as the user to increase the recognition rate of the user's utterance. According to an exemplary embodiment of the present invention, if the user's utterance is not natural, for example, if the user makes an utterance including repeated words or phrases, or if the user makes an utterance again, the dialogue system removes interjections and the like, which are the phonetic features occurring in a natural language, thus converting the received user's utterance into the utterance text.

The dialogue system determines the user's dialogue act based on the converted utterance text and generates a logical expression using a slot expression corresponding to the determined dialogue act and a slot expression defined in the conversation education domain (S604). According to an exemplary embodiment of the present invention, in the case where the user selects the city tour bus ticket purchase domain from the plurality of conversation education domains, when receiving the utterance text such as “Which tour goes to the Statue of Liberty?” with respect to the user's utterance, the dialogue system determines that the user's dialogue act corresponds to a request and generates a logical expression. For example, the logical expression may be a request (location=“State of Liberty”, tour_type), but not limited thereto.

The dialogue system determines an utterance vertex having the logical expression similar to that of the utterance pattern of at least one utterance vertex from a plurality of utterance vertices connected to the system's final utterance vertex in a dynamic dialogue graph and determines an utterance vertex from the plurality of utterance vertices connected to the determined utterance vertex as the next utterance (S605). According to an exemplary embodiment of the present invention, if it is determined that the learning of the user is the first, the dialogue system determines the system's utterance vertex connected to an edge having the highest weight among the plurality of system's utterance vertices connected to the user's utterance vertex. According to an exemplary embodiment of the present invention, although it is determined that the learning of the user is not the first, if it is evaluated that the user's learning progress rate is low, the dialogue system receives an edge between the user's utterance vertex and the plurality of system's utterance vertices connected to the user's utterance vertex and, if there is an edge that requires the user's repetitive, determines the system's utterance vertex connected to the edge. Moreover, although it is determined that the learning of the user is not the first, if it is evaluated that the user's learning progress rate is high, the dialogue system determines the system's utterance vertex connected to the highest edge, at which the user does not perform the learning, among the plurality of system's utterance vertices connected to the user's utterance vertex, thereby determining the next utterance.

According to an exemplary embodiment of the present invention, if it is determined that the user's learning is not sufficient, i.e., if it is determined that the similarity between the user's utterance pattern and the utterance pattern of the user's utterance vertex is low, the dialogue system determines that the user does not sufficiently learn the content of the dialogue based on the user's corresponding utterance vertex, thereby determining the next utterance. If it is determined that the user's learning is sufficient, i.e., if it is determined that the similarity between the user's utterance pattern and the utterance pattern of the user's utterance vertex is high, the dialogue system determines that the user sufficiently learns the content of the dialogue based on the user's corresponding utterance vertex, thereby determining the next utterance.

The dialogue system generates the system's utterance sentence by retrieving the utterance patterns connected to the system's utterance vertex based on the utterance vertex determined as the next utterance (S606). The dialogue system synthesizes the generated system's utterance sentence into a voice and outputs the synthesized voice (S607).

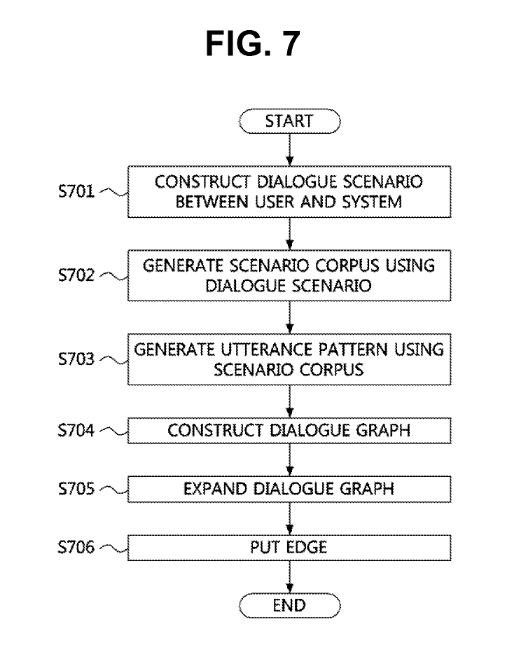

Next, a method for generating the dynamic dialogue graph in the educational dialogue system in accordance with an exemplary embodiment of the present invention will be described in more detail with reference to FIG. 7.

FIG. 7 is a flowchart showing a method for generating the dynamic dialogue graph in the educational dialogue system in accordance with an exemplary embodiment of the present invention.

Referring to FIG. 7, a scenario and corpus builder constructs a dialogue scenario between the user and the system in the conversation education domain selected by the user (S701). According to an exemplary embodiment of the present invention, the scenario and corpus builder represents the subject of the dialogue scenario between the dialogue system and the user in the conversation education domain selected by the user, and the conversation education domain may include, but not limited to, a city tour bus ticket purchase domain, a hotel reservation domain, a hotel check-in and check-out domain, a lost and found search domain, etc.

The scenario and corpus builder sets a dialogue act and a slot expression with respect to each dialogue included in the constructed dialogue scenario and assigns a slot type to each slot expression word, thereby generating a dialogue scenario corpus to which dialogue process information is attached (S702).

The dialogue system receives the dialogue scenario corpus constructed by and received from the scenario and corpus builder, constructs the utterance vertices of the dialogue graph based on the dialogue process information attached to the received dialogue scenario corpus, and generates the utterance pattern with respect to each vertex based on the slot type (S703). According to an exemplary embodiment of the present invention, the dialogue system selects a weight based on the level of difficulty of the utterance determined by calculating the distribution of words that are not frequently used such as words that are not present in elementary/middle/high school textbooks or words with low frequencies in a large English corpus. For example, the level of difficulty of the utterance may be expressed as a value from 1 corresponding to the lowest level of difficulty to 5 corresponding to the highest level of difficulty.

The dialogue system, which generates the utterance pattern, imparts a directed edge to the utterance vertices based on the dialogues included in the dialogue scenario and constructs a dialogue graph by learning a transition relationship between the slots to satisfy the target completion condition in the education domain received from the user (S704). The dialogue system, which constructs the dialogue graph, generates an automatic dialogue scenario by removing the slot having a low probability of utterance from the slots before the current slot in the dialogues included in the dialogue scenario based on the transition relationship between the slots and expands the dialogue graph based on the generated automatic dialogue scenario (S705).

The dialogue system, which expands the dialogue graph, puts a weight on the edge based on information such as the flow frequency between the individual vertices, the length of each utterance sentence, the level of difficulty of each word, the number of edges remaining till the final dialogue, whether the utterer of the next utterance is the system or the user, etc. in the dialogue graph (S706).

First, the dialogue system measures the average length of words of the utterance and the level of difficulty of words, which represent the vertex in the expanded dialogue graph, and puts a high weight on the edge depending on the dialogue flow in which the use can easily make an utterance.

Second, the dialogue system selects a weight based on the level of difficulty of the utterance determined by calculating the distribution of words that are not frequently used such as words that are not present in elementary/middle/high school textbooks or words with low frequencies in a large English corpus. For example, the level of difficulty of the utterance may be expressed as a value from 1 corresponding to the lowest level of difficulty to 5 corresponding to the highest level of difficulty.

Third, the dialogue system receives the expanded dialogue graph, uses the flow frequency such that the system can induce the dialogue flow having a high flow frequency between the vertices in the received dialogue graph, measures the average length of words of the utterance and the level of difficulty of words, which represent the vertex in the dialogue graph, and puts a higher weight on the dialogue flow that the use can easily understand and in which the user can easily make an utterance.

Lastly, in the case where the system leads the dialogue, the user can experience the conversation more easily, and thus the dialogue system selects a weight such that the next utterance can be led by the system.

As described above, according to the dialogue method and system of the present invention, which makes an utterance adaptively in response to a user's utterance based on the user's learning progress, it is possible to provide a variety of English experiences and control the level of the systems' utterance by controlling various dialogue flows based on the learning progress of the user. Moreover, according to the dialogue system and method of the present invention, which receives the target completion condition in the education domain from the user, the user can practice the foreign language conversation in a variety of situations in one domain which may be boring to the user, thereby maximizing the repetitive learning effect. Furthermore, the user can further recognize the various conditions to naturally learn the foreign culture and customs provided in the domain.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A dialogue system comprising:
a learning initiation unit which receives a conversation education domain and a target completion condition in the conversation education domain from a user and receives the user's utterance made by the user;
a voice recognition unit which converts the received user's utterance into a utterance text based on utterance information;
a language understanding unit which determines the user's dialogue act based on the converted utterance text and generates a logical expression using a slot expression corresponding to the determined dialogue act and a slot expression defined in the conversation education domain;
a dialogue/progress management unit which determines an utterance vertex with a logical expression similar to that of utterance patterns of a plurality of utterance vertices connected to the system's final utterance vertex in a dynamic dialogue graph and determines one of the plurality of utterance vertices connected to the determined utterance vertex as the next utterance;
a system dialogue generation unit which retrieves utterance patterns connected to the utterance vertex corresponding to the determined next utterance and generates the system's utterance sentence; and
a voice synthesizer which synthesizes the generated system's utterance sentence into a voice and outputs the synthesized voice.

2. The dialogue system of claim 1, wherein the dialogue/progress management unit retrieves the user's utterance vertex of the received user's utterance based on the system's final utterance vertex in the dynamic dialogue graph.

3. The dialogue system of claim 2, wherein if it is determined from the retrieval that the user's utterance vertex of the received user's utterance is not present, the dialogue/progress management unit retrieves the user's utterance vertex of the received user's utterance from the entire dynamic dialogue graph based on the logical expression and the current slot history of the user's current utterance.

4. The dialogue system of claim 2, wherein if it is determined that the learning of the user is the first based on learning progress information, the dialogue/progress management unit determines the system's utterance vertex, which is connected to an edge having the highest weight among the plurality of system's utterance vertices connected to the user's utterance vertex retrieved from the dynamic dialogue graph, as the next utterance.

5. The dialogue system of claim 2, wherein if it is determined that the learning of the user is not the first based on learning progress information and if it is evaluated that the user's learning progress rate is low, the dialogue/progress management unit determines an edge that requires the user's repetitive based on the edges between the user's utterance vertex and the plurality of system's utterance vertices connected thereto, which are retrieved from the dynamic dialogue graph, and determines the system's utterance vertex connected to the corresponding edge as the next utterance.

6. The dialogue system of claim 5, wherein if it is evaluated that the user's learning progress rate is high, the dialogue/progress management unit determines the system's utterance vertex connected to the highest edge among the edges between the user's utterance vertex and the plurality of system's utterance vertices connected thereto, which are retrieved from the dynamic dialogue graph, as the next utterance.

7. The dialogue system of claim 2, wherein if it is determined that the user's utterance is similar to the utterance pattern of the user's utterance vertex, which is retrieved from the dynamic dialogue graph, based on the learning progress information, the dialogue/progress management unit determines that the learning of the user at the user's corresponding utterance vertex is sufficient and determines the next utterance.

8. The dialogue system of claim 7, wherein if it is determined that the user's utterance is not similar to the utterance pattern of the user's utterance vertex, which is retrieved from the dynamic dialogue graph, based on the learning progress information, the dialogue/progress management unit determines that the learning of the user at the user's corresponding utterance vertex is not sufficient and determines the next utterance.

9. The dialogue system of claim 7, wherein the dialogue/progress management unit updates the weight of the edge between the user's previous utterance vertex and the system's previous utterance vertex in the user's utterance pattern and the dynamic dialogue graph based on the learning progress information.

10. A dialogue method comprising:
receiving a conversation education domain and a target completion condition in the conversation education domain from a user and receiving the user's utterance made by the user;
converting the received user's utterance into a utterance text based on utterance information;
determining the user's dialogue act based on the converted utterance text and generating a logical expression using a slot expression corresponding to the determined dialogue act and a slot expression defined in the conversation education domain;
determining an utterance vertex with a logical expression similar to that of utterance patterns of a plurality of utterance vertices connected to the system's final utterance vertex in a dynamic dialogue graph and determining one of the plurality of utterance vertices connected to the determined utterance vertex as the next utterance;
retrieving utterance patterns connected to the utterance vertex corresponding to the determined next utterance and generating the system's utterance sentence; and
synthesizing the generated system's utterance sentence into a voice and outputting the synthesized voice.

11. The dialogue method of claim 10, wherein in the determining of the next utterance, the user's utterance vertex of the received user's utterance is retrieved based on the system's final utterance vertex in the dynamic dialogue graph.

12. The dialogue method of claim 11, wherein in the determining of the next utterance, if it is determined from the retrieval that the user's utterance vertex of the received user's utterance is not present, the user's utterance vertex of the received user's utterance is retrieved from the entire dynamic dialogue graph based on the logical expression and the current slot history of the user's current utterance.

13. The dialogue method of claim 11, wherein in the determining of the next utterance, if it is determined that the learning of the user is the first based on learning progress information, the system's utterance vertex, which is connected to an edge having the highest weight among the plurality of system's utterance vertices connected to the user's utterance vertex retrieved from the dynamic dialogue graph, is determined as the next utterance.

14. The dialogue method of claim 11, wherein in the determining of the next utterance, if it is determined that the learning of the user is not the first based on learning progress information and if it is evaluated that the user's learning progress rate is low, an edge that requires the user's repetitive is determined based on the edges between the user's utterance vertex and the plurality of system's utterance vertices connected thereto, which are retrieved from the dynamic dialogue graph, and the system's utterance vertex connected to the corresponding edge is determined as the next utterance.

15. The dialogue method of claim 11, wherein in the determining of the next utterance, if it is evaluated that the user's learning progress rate is high, the system's utterance vertex, which is connected to the highest edge among the edges between the user's utterance vertex and the plurality of system's utterance vertices connected thereto, which are retrieved from the dynamic dialogue graph, is determined as the next utterance.

16. The dialogue method of claim 11, wherein in the determining of the next utterance, if it is determined that the user's utterance is similar to the utterance pattern of the user's utterance vertex retrieved from the dynamic dialogue graph based on the learning progress information, it is determined that the learning of the user at the user's corresponding utterance vertex is sufficient and the next utterance is determined.

17. The dialogue method of claim 11, wherein in the determining of the next utterance, if it is determined that the user's utterance is not similar to the utterance pattern of the user's utterance vertex retrieved from the dynamic dialogue graph based on the learning progress information, it is determined that the learning of the user at the user's corresponding utterance vertex is not sufficient and the next utterance is determined.

18. A method for generating a dialogue graph, the method comprising:
constructing a dialogue scenario between a user and a system in an education domain selected by the user;
generating a dialogue scenario corpus to which dialogue process information is attached by setting a dialogue act and a slot expression with respect to each dialogue included in the constructed dialogue scenario and assigning a slot type to each slot expression word;
constructing utterance vertices of the dialogue graph based on the dialogue process information attached to the dialogue scenario corpus and generating the utterance pattern of the utterance vertex based on the slot type; and
imparting a directed edge to the utterance vertices based on dialogues included in the dialogue scenario and constructing the dialogue graph by learning a transition relationship between the slots to satisfy a target completion condition in the education domain received from the user.

19. The method of claim 18, wherein the constructing of the dialogue graph comprises generating an automatic dialogue scenario by removing the slot having a low probability of utterance from the slots before the current slot in the dialogues included in the dialogue scenario based on the transition relationship between the slots and expanding the dialogue graph based on the generated automatic dialogue scenario.

20. The method of claim 18, wherein the constructing of the dialogue graph comprises putting a weight on the edge based on information such as the flow frequency between the individual vertices, the length of each utterance sentence, the level of difficulty of each word, the number of edges remaining till the final dialogue, and whether the utterer of the next utterance is the system or the user in the dialogue graph.
